(19) United States
(12) Patent Application Publication
(10) Pub. No.: US 2012/0065823 A1
(43) Pub. Date: Mar. 15, 2012

(54) ELECTRONIC CONTROL UNIT FOR VEHICLES

(75) Inventors: Masatoshi TAGUCHI, Kariya-shi (JP); Akito Itou, Kariya-shi (JP)

(73) Assignee: DENSO CORPORATION, Kariya-city (JP)

(21) Appl. No.: 13/231,289

(22) Filed: Sep. 13, 2011

(30) Foreign Application Priority Data
Sep. 13, 2010 (JP) 2010-203971

(51) Int. Cl. G06F 7/00

(52) U.S. Cl. 701/22

(57) ABSTRACT

An electronic control apparatus is provided to control an output of a main engine mounted on a vehicle. The apparatus has first and second processor and first and second monitors. The first processor performs calculation for controlling the output of the main engine, while the second processor performs calculation for monitoring operations of the first processor. The first monitor monitors whether or not the first processor is malfunctioning, while the second monitor monitors whether or not the second processor is malfunctioning.

### CROSS-REFERENCE TO RELATED APPLICATION

This application is based on and claims the benefit of priority from earlier Japanese Patent Application No. 2010-203971 filed Sep. 13, 2010, the description of which is incorporated herein by reference.

### BACKGROUND

1. Technical Field

The disclosure is related to an electronic control unit for vehicles, which controls a main engine mounted on vehicles.

2. Related Art

Among this type of electronic control units, one electronic control unit that has been suggested includes a first microcomputer for controlling an engine and a second microcomputer for monitoring the first microcomputer. A patent document JP-A-2003-214233, for example, suggests such an electronic control unit.

Electronic control units for controlling a controlled variable of a main engine (i.e., a main machine that outputs power) mounted on a vehicle are required to have higher reliability.

### SUMMARY

The disclosure provides an on-vehicle electronic control unit for controlling a controlled variable of a main engine mounted on a vehicle and having high reliability.

An exemplary embodiment provides an electronic control apparatus for controlling an output of a main engine mounted on a vehicle. The apparatus includes a first processor that performs calculation for controlling the output of the main engine; a second processor that performs calculation for monitoring operations of the first processor; a first monitor that monitors whether or not the first processor is malfunctioning; and a second monitor that monitors whether or not the second processor is malfunctioning.

In the embodiment, the first and second monitors are provided. Thus, the occurrence of a failure in the first processor is monitored by the two monitors, i.e. the first and second monitors. Also, the occurrence of a failure in the second processor is monitored by the second monitor. Accordingly, comparing with the case where the first and second monitors are not provided, reliability of the electronic control unit for vehicles is enhanced.

It is preferred that the electronic control apparatus further includes a first power supply that powers the first processor; and a second power supply that powers the second processor, the second power supply being electrically separated from the first power supply. The second power supply is configured to be constantly powered from outside the apparatus, and the first power supply is configured to be powered from outside the apparatus and switched between ON and off states of the power by the second processor.

In this case, supply and stop of electric power to the first power supply unit are switchable to thereby reduce power consumption.

It is also preferred that the first power supply is configured to receive an operation that is capable of maintaining a state where it is possible to power the first power supply from outside the apparatus in response to a command from the first processor, independently of a command from the second processor.

In this configuration, the first processor is able to maintain the state where electric power is supplied to the first power supply. Thus, in the event a failure occurs in the second processor, the activated state of the first processor is maintained.

### BRIEF DESCRIPTION OF THE DRAWINGS

In the accompanying drawings:

FIG. 1 is a schematic diagram illustrating a system according to an embodiment of the disclosure;

FIG. 2 is a time diagram illustrating a mode of a resetting process according to the embodiment;

FIG. 3 is a time diagram illustrating another mode of a resetting process according to the embodiment; and

FIG. 4 is a time diagram illustrating still another mode of a resetting process according to the embodiment.

### DETAILED DESCRIPTION OF THE PREFERRED EMBODIMENTS

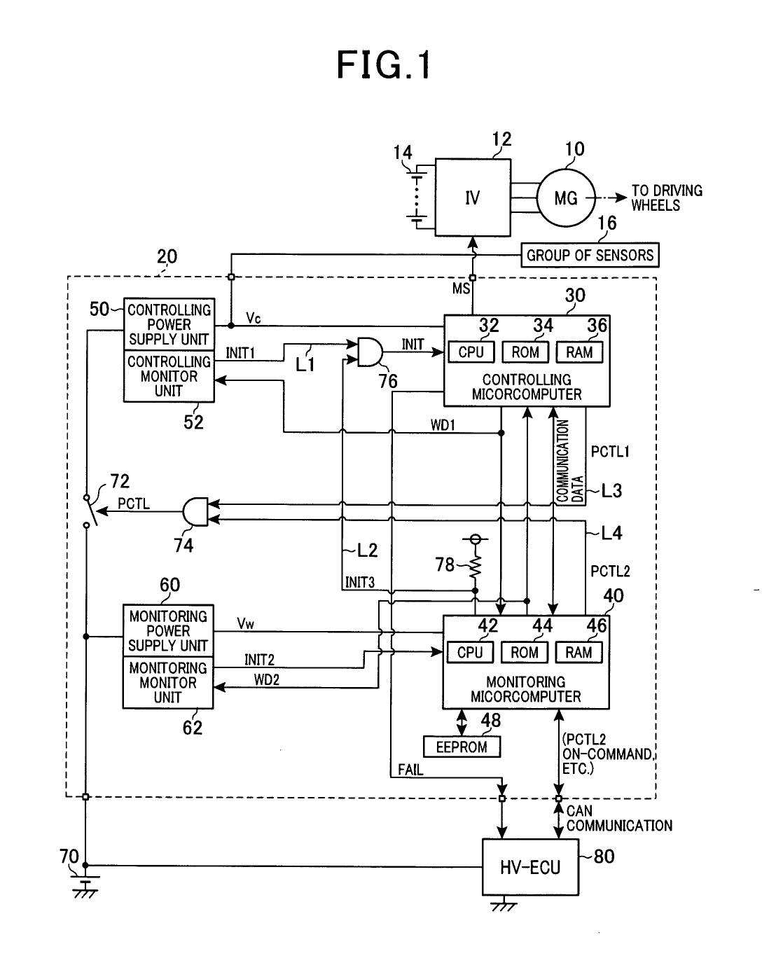

With reference to FIGS. 1 to 4, hereinafter is described an embodiment in which an electronic control unit for vehicles of the disclosure is applied to an electronic control unit of a hybrid vehicle.

FIG. 1 is a schematic diagram illustrating a system according to the embodiment.

As shown in FIG. 1, the system includes a motor-generator 10, an inverter 12, a high-voltage battery 14, and an electronic control unit 20 for controlling the motor-generator 10 (i.e., MGECU 20).

The motor-generator 10 shown in FIG. 1 is a main engine (i.e., a main machine that outputs power) mounted on a vehicle (hereinafter simply “on-vehicle main engine”) and mechanically connected to the drive wheels. The motor-generator 10 is also connected to the high-voltage battery 14 via the inverter 12. The inverter 12 here is a DC-AC conversion circuit that converts a DC voltage of the high-voltage battery 14 into an AC voltage.

The MGECU 20 includes a processor (i.e., a first processor; hereinafter referred to as a “controlling microcomputer 30”) that carries out an operation for controlling a controlled variable of the motor-generator 10 (that is, a physical amount controlled by the motor-generator ID and outputted therefrom).

The controlling microcomputer 30 includes a central control unit (CPU 32), ROM 34 and RAM 36. The controlling microcomputer 30 serves as a software processing means for subjecting a program stored in the ROM 34 to software processing using the CPU 32. Specifically, in order to control the controlled variable, the controlling microcomputer 30 generates and outputs a manipulation signal MS for the inverter 12.

The MGECU 20 also includes a processor 40 for monitoring the controlling microcomputer 30 (the processor 40 is a second processor; hereinafter referred to as a “monitoring microcomputer 40”). The monitoring microcomputer 40 includes a central processing unit (CPU 42), ROM 44 and RAM 46. The monitoring microcomputer 40 serves as a software processing means for subjecting a program stored in the ROM 44 to software processing using the CPU 42.

The MGECU 20 further includes a controlling power supply unit 50 (i.e., a first power supply) for the controlling microcomputer 30, and a controlling monitor unit 52 (i.e., a first monitor) that monitors the controlling microcomputer 30, using the controlling power supply unit 50 as a power supplying means. The controlling monitor unit 52 here may, for example, be a hardware processing means. The controlling power supply unit 50 also supplies power to a group of sensors 16 (e.g., resolver, current sensor, etc.) in a control system of the motor-generator 10.

The MGECU 20 also includes a monitoring power supply unit 60 (i.e., a second power supply) for the monitoring microcomputer 40, and a monitoring monitor unit 62 (i.e., a second monitor) that monitors the monitoring microcomputer 40 using the monitoring power supply unit 60 as a power supplying means. The monitoring monitor unit 62 here may, for example, be a hardware processing means. The controlling power supply unit 50 and the monitoring power supply unit 60 both use an external battery 70 as a power supplying means.

The MGECU 20 further includes an EEPROM (electrically erasable programmable ROM) 48, a memory. Data is readable/writable from/to the EEPROM 48 by the monitoring microcomputer 40.

The monitoring microcomputer 40 periodically communicates with an external hybrid electronic control unit (HVECU 80) using CAN (controller area network). The controlling microcomputer 30 is adapted to output a fail signal FAIL to the HVECU 80.

The HVECU 80 has a role of controlling the vehicle and thus gives a command, for example, to the MGECU 20 regarding the controlled variable of the motor-generator 10. The MGECU 20 carries out various processes in response to the command to control the controlled variable of the motor-generator 10.

Hereinafter is described a monitoring function in the MGECU 20 for maintaining reliability of the MGECU 20. In the present embodiment, the occurrence of a failure in the controlling microcomputer 30 and the monitoring microcomputer 40 is monitored based on watchdog signals WDc and WDw as well as two-way communication data between the controlling and monitoring microcomputers 30 and 40.

Specifically, the controlling microcomputer 30 outputs a watchdog signal WD1 that is a periodical pulse signal to the monitoring microcomputer 40 and the controlling monitor unit 52. Thus, the monitoring microcomputer 40 and the controlling monitor unit 52 are able to determine the occurrence of a failure in the controlling microcomputer 30 based on the condition where the watchdog signal WD1 is not inputted over a predetermined period of time.

The monitoring microcomputer 40 outputs a watchdog signal WD2 that is a periodical pulse signal to the controlling microcomputer 30 and the monitoring monitor unit 62. Thus, the controlling microcomputer 30 and the monitoring monitor unit 62 are able to determine the occurrence of a failure based on the condition where the watchdog signal WD2 is not inputted over a predetermined period of time.

The controlling and monitoring microcomputers 30 and 40 communicate with each other for mutual transmission/reception of data to thereby mutually monitor the occurrence of a failure based on the communication data. In other words, for example, the controlling microcomputer 30 outputs data and the like in the ROM 34 or the RAM 36, while the monitoring microcomputer 40 determines whether or not a failure has occurred in the controlling microcomputer 30, based on the outputted data and the like. The data in the ROM 34 may be predetermined address data, or may be address data specified by the monitoring microcomputer 40. On the other hand, the data in the RAM 36 may, for example, be a detection value of a controlled variable, which corresponds to a command value of a controlled variable derived from the HVECU 80.

As an alternative approach of determining the occurrence of a failure based on the data in the RAM 36, the same data may be written at two points in the RAM 36 for comparison of the written data. The process of comparison here may be performed by the monitoring microcomputer 40. Alternatively, the comparison may be performed by the controlling microcomputer 30 and the data resulting from the comparison may be outputted to the monitoring microcomputer 40.

Similarly, the monitoring microcomputer 40 outputs data and the like in the ROM 44 or the RPM 46, while the controlling microcomputer 30 determines whether or not a failure has occurred in the monitoring microcomputer 40, based on the outputted data and the like.

When a failure is determined to have occurred as a result of the determination regarding the occurrence of a failure, the microcomputer determined to have the failure is reset. The resetting is purposed to accelerate return of the microprocessor in question to a normal state.

Specifically, if the monitoring microcomputer 40 determines that the controlling microcomputer 30 has a failure, the monitoring microcomputer 40 outputs a reset signal INIT3 to a logic synthesis circuit 76 via a signal line L2. In the present embodiment, the reset signal INIT3 is rendered to be a signal of logic “L”. When the reset signal INIT3 is outputted, power supply to the controlling microcomputer 30 is interrupted for a predetermined period of time to thereby stop the operation of the controlling microcomputer 30 (the controlling microcomputer 30 is reset).

It is so configured that the signal line L2 is pulled up via a resistor 78. Otherwise, the resetting of the monitoring microcomputer 40 would allow the potential of the signal line L2 to be a potential corresponding to the logic “L” and thus, interlocking with the resetting of the microcomputer 40, the controlling microcomputer 30 would also be reset. The signal line L2 is configured to be pulled up to avoid such a situation.

The controlling monitor unit 52 outputs a reset signal INIT1 to the logic synthesis circuit 76 when the controlling microcomputer 30 is determined to have a failure based on the watchdog signal WD1, or when a voltage Vc of the controlling power supply unit 50 is determined to be not more than a specified voltage. The logic synthesis circuit 76 has an output of a reset signal INIT which is a logical product signal of the reset signal INIT1 and the reset signal INIT3. The reset signal INIT is inputted to the controlling microcomputer 30. The specified voltage mentioned above is set to a lower limit value or less of the voltage at which the reliability is ensured in the operation of the controlling microcomputer 30.

The monitoring monitor unit 62, on the other hand, outputs a reset signal INIT2 to the monitoring microcomputer 40 when the monitoring microcomputer 40 is determined to have a failure based on the watchdog signal WD2, or when a voltage Vw of the monitoring power supply unit 60 is determined to be not more than a specified voltage. The specified voltage is set to a lower limit value or less of the voltage at which the reliability is ensured in the operation of the monitoring microcomputer 40.

If a failure occurs in the monitoring microcomputer 40, the controlling microcomputer 30 outputs the FAIL signal to the HVECU 80 to inform the HVECU 80 accordingly. On the other hand, the monitoring microcomputer 40 constantly communicates with the HVECU 80 using CAN communication. Thus, if a failure occurs in the controlling microcomputer 30, the monitoring microcomputer 40 informs the HVECU 80 accordingly.

The monitoring power supply unit 60 is kept being electrically connected to the battery 70. On the other hand, the controlling power supply unit 50 is adapted to be electrically connected to the battery 70 via a switching element 72. This is chiefly because the controlling power supply unit 50 serves as a power supply of not only the controlling microcomputer 30 but also the group of sensors 16, and thus manages higher power than does the monitoring power supply unit 60 and consumes a large electric power. For this reason, under the condition where, for example, a start-up allowance switch of the vehicle is turned off, the monitoring power supply unit 60 is permitted to be in an energized state to enable CAN communication, while the controlling power supply unit 50 is permitted to be in an off-state, thereby reducing power consumption.

The switching element 72 is turned on/Off by a power control signal PCTL. The power control signal PCTL is obtained by logically synthesizing (performing OR operation for) a power control signal PCTL1 and a power control signal PCTL2 by a logic synthesis unit 74. The power control signal RCTL1 is outputted from the controlling microcomputer 30 to a signal line L3, and the power control signal PCTL2 is outputted from the monitoring microcomputer 40 to a signal line L4.

The power control signals PCTL1, PCTL2 and PCTL each use a logic “H” to express an on-operation command of the controlling power supply unit 50. Accordingly, when the controlling microcomputer 30 outputs the power control signal PCTL1 or when the monitoring microcomputer 40 outputs the power control signal PCTL2, the switching element 72 is turned on to thereby turn on the controlling power supply unit 50.

In this case, the monitoring microcomputer 40 outputs the power control signal PCTL2 when the HVECU 80 has issued a command for turning on the controlling power supply unit 50. Thus, with the output of the power control signal PCTL2, the controlling power supply unit 50 is turned on. When the controlling power supply unit 50 is turned on and thus the controlling microcomputer 30 is activated, the controlling microcomputer 30 outputs the power control signal PCTL1. Accordingly, in the event that the monitoring microcomputer 40 is reset, the controlling power supply unit 50 will not be turned off.

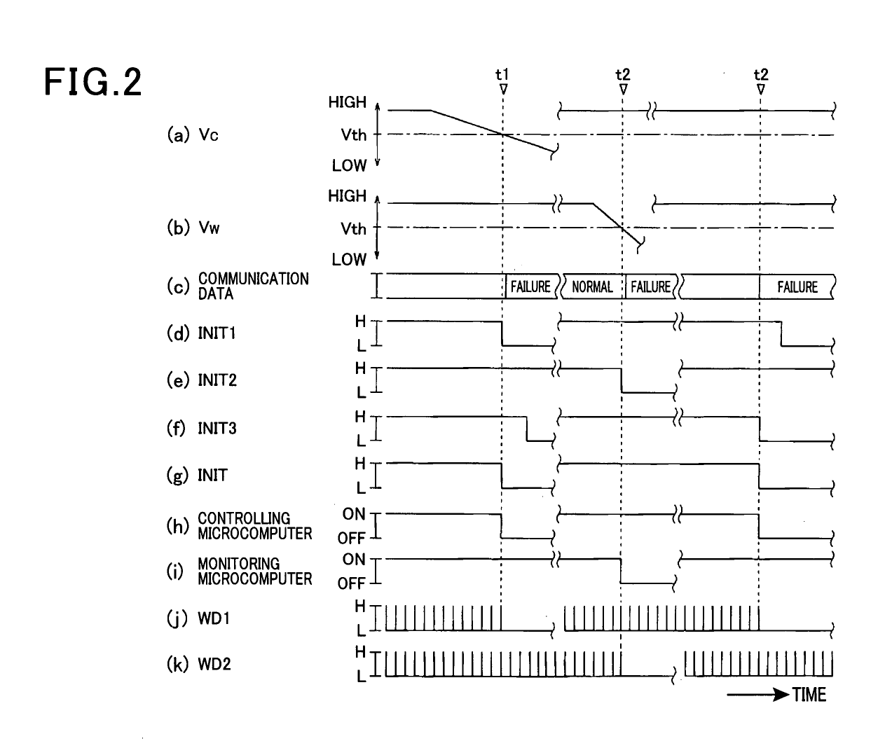

FIG. 2 exemplifies a resetting process according to the present embodiment. FIG. 2(a) shows a progression of the voltage Vc of the controlling power supply unit 50. FIG. 2(b) shows a progression of the voltage Vw of the monitoring power supply unit 60. FIG. 2(c) shows a progression of CAN communication data. FIG. 2(d) shows a progression of the reset signal INIT1. FIG. 2(e) shows a progression of the reset signal INIT2. FIG. 2(f) shows a progression of the reset signal INIT3. FIG. 2(g) shows a progression of the reset signal INIT. FIG. 2(h) shows a progression of activation/deactivation of the controlling microcomputer 30. FIG. 2(i) shows a progression of activation/deactivation of the monitoring microcomputer 40. FIG. 2(j) shows a progression of the watchdog signal WD1. FIG. 2(k) shows a progression of the watchdog signal WD2.

As shown in the figures, the voltage Vc of the controlling power supply unit 50 becomes equal to or less than a specified voltage Vth at a time point t1, when the reset signal INIT1 is outputted to reset the controlling microcomputer 30. Also, the voltage Vw of the monitoring power supply unit 60 becomes equal to or less than a specified voltage Vth at a time point t2, when the reset signal INIT2 is outputted to reset the monitoring microcomputer 40. In this case, the potential of the signal line L2 turns to the logic “H”, and accordingly the controlling microcomputer 30 will not be reset interlocking with the resetting of the monitoring microcomputer 40. When the controlling microcomputer 30 or the monitoring microcomputer 40 is reset, CAN communication data turns out to be abnormal.

As shown in the figures, the controlling microcomputer 30 is determined to be failed at a time point t3 by the monitoring microcomputer 40 based on the communication data between the controlling and monitoring microcomputers 30 and 40. At this time point t3, the monitoring microcomputer 40 outputs the reset signal INIT3 to reset the controlling microcomputer 30. When the controlling microcomputer 30 is reset, the watchdog signal WD1 is no longer outputted. Thus, the controlling monitor unit 52 also determines the occurrence of the failure in the controlling microcomputer 30 and outputs the reset signal INIT1.

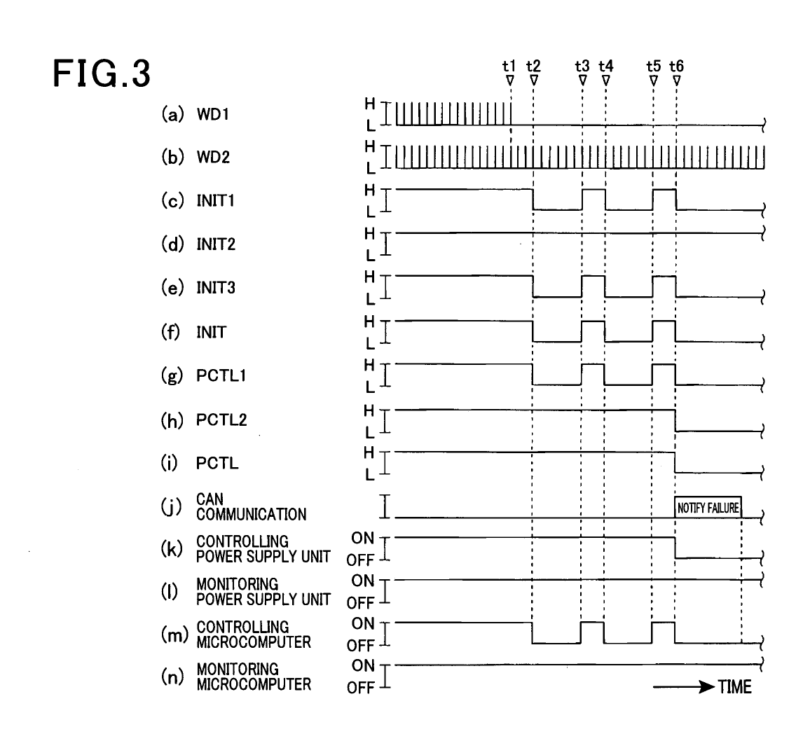

FIG. 3 exemplifies another resetting process according to the present embodiment, together with the power control signals. FIG. 3(a) shows a progression of the watchdog signal WD1. FIG. 3(b) shows a progression of the watchdog signal WD2. FIG. 3(c) shows a progression of the reset signal INIT1. FIG. 3(d) shows a progression of the reset signal INIT2. FIG. 3(e) shows a progression of the reset signal INIT3. FIG. 3(f) shows a progression of the reset signal INIT. FIG. 3(g) shows a progression of the power control signal PCTL1. FIG. 3(h) shows a progression of the power control signal PCTL2. FIG. 3(i) shows a progression of the power control signal PCTL. FIG. 3(j) shows CAN communication data. FIG. 3(k) shows a progression of activation/deactivation of the controlling power supply unit 50. FIG. 3(l) shows a progression of activation/deactivation of the monitoring power supply unit 60. FIG. 3(m) shows a progression of activation/deactivation of the controlling microcomputer 30. FIG. 3(n) shows a progression of activation/deactivation of the monitoring microcomputer 40.

As shown in the figures, the watchdog signal WD1 is no longer outputted from the controlling microcomputer 30 at a time point t1. At a time point t2 after a lapse of a predetermined time from the time point t1, the controlling monitor unit 52 outputs the reset signal INIT1 and the monitoring microcomputer 40 outputs the reset signal INIT3. Thus, with the output of the reset signals INIT1 and INIT3, the controlling microcomputer 30 is reset.

Then, at a time point t3 after a lapse of a predetermined time from the time point t2, the controlling microcomputer 30 returns to an activated state. However, since the watchdog signal WD1 is not outputted, at a time point t4, the controlling monitor unit 52 again outputs the reset signal INIT1 and the monitoring microcomputer 40 again outputs the reset signal INIT3. Thus, the controlling microcomputer 30 is reset again.

Then, at a time point t5 after a lapse of a predetermined time from the time point t4, the controlling microcomputer 30 returns to an activated state. However, since the watchdog signal WD1 is not outputted, at time point t6, the controlling monitor unit 52 again outputs the reset signal INIT1 and the monitoring microcomputer 40 again outputs the reset signal INIT3. Thus, the controlling microcomputer 30 is reset again. At the same time, the output of the power control signal PCTL2 is stopped to thereby turn off the controlling power supply unit 50. As a result, the controlling microcomputer 30 is deactivated. Along with this process, the occurrence of the failure is notified from the monitoring microcomputer 40 to the HVECU 80 using CAN communication. Accordingly, the HVECU 80 goes into a limp home mode in which a different main engine not shown is used.

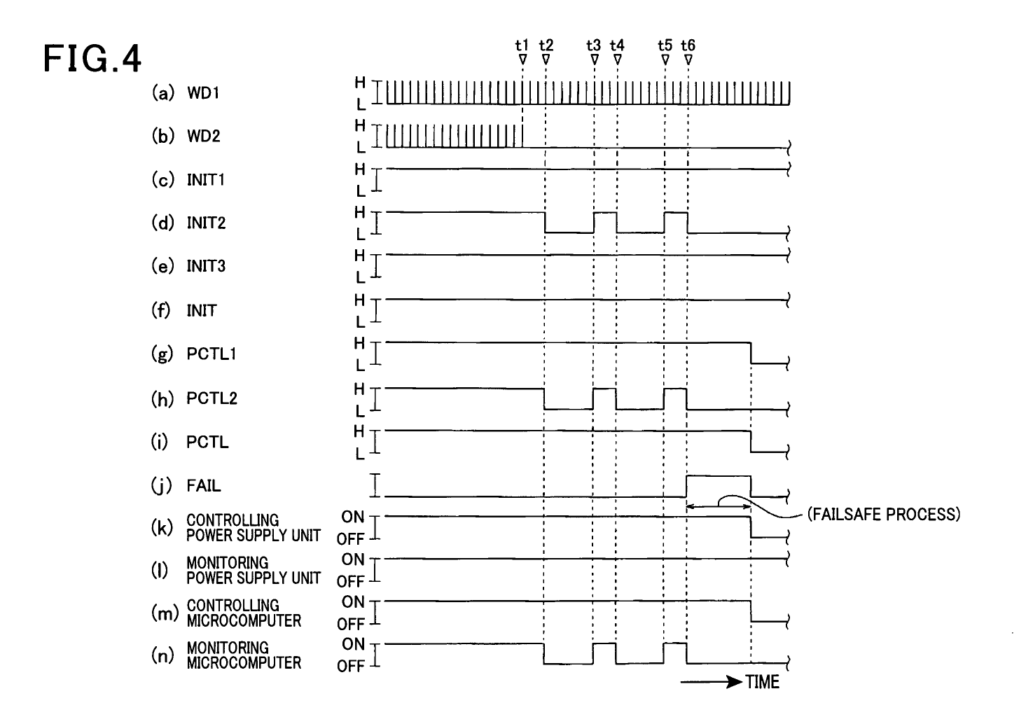

FIG. 4 exemplifies still another resetting process according to the present embodiment, together with the power control signals. Items (a)-(i) in FIG. 4 and items (k)-(n) in FIG. 4 correspond to items (a)-(i) in FIG. 3 and items (k)-(n) in FIG. 3, respectively. FIG. 4(j) shows a progression of the fail signal FAIL.

As shown in the figures, the watchdog signal WD2 is no longer outputted from the monitoring microcomputer 40 at a time point t1. At a time point t2 after a lapse of a predetermined time from the time point t1, the monitoring monitor unit 62 outputs the reset signal INIT2. Thus, with the output of the reset signal INIT2, the monitoring microcomputer 40 is reset. Then, at a time point t3 after a lapse of a predetermined time from the time point t2, the monitoring microcomputer 40 returns to an activated state. However, since the watchdog signal WD2 is not outputted, at a time point t4, the monitoring monitor unit 62 again outputs the reset signal INIT2 to again reset the monitoring microcomputer 40.

Then, at a time point t5 after a lapse of a predetermined time from the time point t4, the monitoring microcomputer 40 returns to an activated state. However, since the watchdog signal WD2 is not outputted, at a time point t6, the monitoring monitor unit 62 outputs the reset signal INIT2 to again reset the monitoring microcomputer 40. At the same time, the fail signal FAIL is outputted, while the controlling microcomputer 30 carries out a failsafe process. After completion of the failsafe process, the controlling microcomputer 30 stops outputting the power control PCTL1. Thus, the controlling power supply unit 50 is turned off and thus the controlling microcomputer 30 is turned off. With the input of the fail signal FAIL, the HVECU 80 goes into a limp home mode in which a different main engine not shown is used.

According to the embodiment specifically described above, the advantages as set forth below are obtained.

(1) The system according to the above embodiment is provided with the controlling monitoring unit 52 for monitoring the occurrence of a failure in the controlling microcomputer 30, and the monitoring monitor unit 62 for monitoring the occurrence of a failure in the monitoring microcomputer 40. Thus, the reliability of the MGECU 20 is improved.

(2) The monitoring power supply unit 60 is constantly supplied with power from outside. The controlling power supply unit 60 is able to switch supply and stop of electric power from outside with the aid of the monitoring microcomputer 40, accelerating reduction of power consumption.

(3) The controlling power supply unit 50 can be maintained at a state where electric power is supplied from outside with the aid of the controlling microcomputer 30, irrespective of whether the monitoring microcomputer 40 is operated. Thus, the activated state of the controlling microcomputer 30 is maintained, irrespective of the state of the monitoring microcomputer 40.

(4) In the case where the monitoring microcomputer 40 is once reset but cannot return to an activated state from the reset state, a failsafe process is performed, followed by stopping power supply to the controlling power supply unit 50 by the controlling microcomputer 30 per se. Thus, the controlling microcomputer 30 is prevented from keeping normal activation under the condition where monitoring is not performed by the monitoring microcomputer 40.

(5) The monitoring microcomputer 40 is constantly supplied with power from the monitoring power supply unit 60 to thereby maintain the activated state. Thus, the monitoring microcomputer 40 is constantly responsive to a command from outside,

(6) The controlling power supply unit 50 is permitted to supply electric power not only to the controlling microcomputer 30 but also to the group of sensors 16 installed in a control system of the motor-generator 10. In this case, since the controlling power supply unit 50 manages high power, a particularly great merit is obtained by allowing the controlling power supply unit 50 to be switchable to an off-state.

(7) The controlling microcomputer 30 is reset when the voltage of the controlling power supply unit 50 is reduced. Thus, the controlling microcomputer 30 is favorably prevented from being activated. Otherwise, the reliability of the operation of the controlling microcomputer 30 would be deteriorated.

(8) The monitoring microcomputer 40 is reset when the voltage of the monitoring monitor unit 52 is reduced. Thus, the monitoring microcomputer 40 is favorably prevented from being activated. Otherwise, the reliability of the operation of the monitoring microcomputer 40 would be deteriorated.

(9) The monitoring microcomputer 40, when it determines the controlling microcomputer 30 to be failed, is adapted to reset the controlling microcomputer 30. Thus, the controlling microcomputer 30 is accelerated to return to a normal state.

(10) The monitoring microcomputer 40 is adapted to detect the occurrence of a failure in the controlling microcomputer 30 based on the watchdog signal WD1. Thus, the occurrence of a failure is appropriately determined.

(11) The monitoring microcomputer 40 is adapted to detect the occurrence of a failure in the controlling microcomputer 30 based on periodical communication. Thus, the occurrence of a failure is appropriately determined.

(12) The controlling microcomputer 30 is adapted to detect the occurrence of a failure in the monitoring microcomputer 40 based on the watchdog signal WD2. Thus, the occurrence of a failure is appropriately determined.

(13) The controlling microcomputer 30 is adapted to detect the occurrence of a failure in the monitoring microcomputer 40 based on periodical communication. Thus, the occurrence of a failure is appropriately determined.

(14) The controlling and monitoring microcomputers 30 and 40 are each adapted to notify the HVECU 80 of the occurrence of a failure. Thus, the HVECU 80 is able to grasp a state of abnormality.

(15) The monitoring microcomputer 40 is adapted to store history of failures of the controlling microcomputer 30 in the EEPROM 48. Thus, in the event, for example, the monitoring microcomputer 40 is reset, the history of failures can be retained.

### MODIFICATIONS

The embodiment described above may be modified as set forth below.

The controlling processor is not limited to the microcomputer 30. For example, the CPU 32 may serve as the controlling processor and the ROM 34, RAM 36 and the like may be shared between the control processor and the monitoring processor.

Also, a software processing means may not be necessarily used, but instead, a dedicated hardware processing means may be used. From a viewpoint such as of facilitating monitoring of the processing, digital processing may desirably be used.

Further, the controlling microcomputer 30 may have a function of resetting the monitoring microcomputer 40.

In addition, it may be so configured that the controlling microcomputer 30 performs two-way communication with an externally provided ECU (HVECU 80).

The monitoring processor is not limited to a software processing means but may be a dedicated hardware processing means. From a viewpoint such as of facilitating monitoring of the processing, digital processing may desirably be used.

The monitoring microcomputer 40 may not have a function of resetting the controlling microcomputer 30. In this case as well, the ECU 20 is adapted to exert a function of resetting the controlling microcomputer 30 by providing the monitoring monitor unit 62.

The monitoring processor may not necessarily determine the occurrence of a failure of the controlling microcomputer 30 based on both of the watchdog signal WD1 and communication data. The occurrence of failure in the controlling microcomputer 30 may be determined only based on either one of the watchdog signal WD1 and communication data.

The controlling power supply unit is not limited to the one that supplies electric power such as to a group of sensors in a control system. For example, the controlling power supply unit may supply electric power only to the controlling microcomputer 30 and the controlling monitor unit 52.

The controlling power supply unit is not limited to the one whose supply and stop of electric power is operated by the monitoring microcomputer 40. For example, the controlling power supply unit may be constantly supplied with electric power. In this case, from a viewpoint of reducing power consumption, it is particularly desirable that power supply such as to a group of sensors in a control system is performed by a member provided separately from the controlling power supply unit.

The controlling power supply unit is not limited to the one for which the supply of electric power is operated such that the supply is continued by the controlling microcomputer 30. In other words, the controlling power supply unit is not limited to the one for which the supply or the stop of electric power is operated by the power control signal PCTL1. For example, with the connection of a capacitor to a signal line to which the power control signal PCTL2 is outputted, the potential of the signal line L2 may be ensured to be the potential of the power control signal PCTL2 at the time when the monitoring microcomputer 40 is reset.

In the embodiment described above, in the case where the monitoring microcomputer 40 is once reset but cannot return to a normal state, the failsafe process is performed, followed by switching the power control signal PCTL1 to a command for stopping power supply. However, a limitation should not be imposed by this. If only the reliability of monitoring the controlling microcomputer 30 by the controlling monitor unit 52 meets a requested reliability, the power control signal PCTL1 may be maintained for use as a power supply command to activate the controlling microcomputer 30.

The controlling monitor unit is not limited to the one that outputs the reset signal INIT1 based on a logical OR of the voltage reduction of the controlling power supply unit 50 and the abnormality of the watchdog signal WD1. For example, the controlling monitor unit may be the one that outputs the reset signal INIT1 only when the voltage of the controlling power supply unit 50 is reduced. In this case, however, it is desirable that the monitoring microcomputer 40 is adapted to reset the controlling microcomputer 30, on condition that the controlling microcomputer 30 is determined to be failed, based on the watchdog signal WD1.

Alternatively, the controlling monitor unit may be the one that outputs the reset signal INIT1 only when the controlling microcomputer 30 is determined to be failed, based on the watchdog signal WD1.

The monitoring monitor unit is not limited to the one that outputs the reset signal INIT2 based on a logical OR of the voltage reduction of the monitoring power supply unit 60 and the abnormality of the watchdog signal WD2. For example, the monitoring monitor unit may be the one that outputs the reset signal INIT2 only when the voltage of the monitoring power supply unit 60 is reduced. In this case, however, it is desirable that the controlling microcomputer 30 is adapted to reset the monitoring microcomputer 40, on condition that the monitoring microcomputer 40 is determined to be failed, based on the watchdog signal WD2.

Alternatively, the monitoring monitor unit may be the one that outputs the reset signal INIT2 only when the monitoring microcomputer 40 is determined to be failed, based on the watchdog signal WD2.

The on-vehicle main engine as an object to be controlled by the electronic control unit of the disclosure is not limited to the motor-generator 10, but may, for example, be an internal combustion engine.

The vehicle is not limited to a hybrid vehicle, but may, for example, be an electric vehicle only having a means for accumulating electric energy, such as a secondary cell and a fuel cell, as a means for accumulating energy in the vehicle.

What is claimed is:

1. An electronic control apparatus for controlling an output of a main engine mounted on a vehicle, comprising:
a first processor that performs calculation for controlling the output of the main engine;
a second processor that performs calculation for monitoring operations of the first processor;
a first monitor that monitors whether or not the first processor is malfunctioning; and
a second monitor that monitors whether or not the second processor is malfunctioning.

2. The electronic control apparatus of claim 1, comprising:
is a first power supply that powers the first processor; and
a second power supply that powers the second processor, the second power supply being electrically separated from the first power supply,
wherein the second power supply is configured to be constantly powered from outside the apparatus, and
the first power supply is configured to be powered from outside the apparatus and switched between ON and OFF states of the power by the second processor.

3. The electronic control apparatus of claim 2, wherein the first power supply is configured to receive an operation that is capable of maintaining a state where it is possible to power the first power supply from outside the apparatus in response to a command from the first processor, independently of a command from the second processor.

4. The electronic control apparatus of claim 3, wherein the first power supply is configured such that powering the first power supply is controlled by a power control signal, and
the power control signal is a signal which is produced by logically combining an output signal from the second processor and an output signal from the first power supply.

5. The electronic control apparatus of claim 3, wherein the first processor is configured to perform a failsafe process and then stop powering the first power supply when it is determined that the second processor is brought into a reset state and unable to be returned from the reset state.

6. The electronic control apparatus of claim 2, wherein the second processor is configured to allow the first power supply to be powered from outside the apparatus in response to a command signal inputted from a further electronic control apparatus located outside the apparatus.

7. The electronic control apparatus of claim 2, wherein the second processor is configured to be constantly powered from the second power supply.

8. The electronic control apparatus of claim 7, wherein the main engine is controlled by a control system provided with a sensor, and the first power supply is configured to power both the first processor and the sensor.

9. The electronic control apparatus of claim 2, wherein the first monitor is configured to check whether or not a voltage outputted from the first power supply has decreased, and to reset the first processor when the voltage from the first power supply decreases.

10. The electronic control apparatus of claim 2, wherein the second monitor is configured to check whether or not a voltage outputted from the second power supply has decreased, and to reset the second processor when the voltage from the second power supply decreases.

11. The electronic control apparatus of claim 1, wherein the second processor includes means for determining whether or not the first processor is malfunctioning, based on a signal outputted from the first processor, and means for resetting the first processor when it is determined that the first processor is malfunctioning.

12. The electronic control apparatus of claim 11, wherein the first processor is configured to provide the second processor with a watchdog signal, and the second processor is configured to determine that the first processor is malfunctioning, based on a fact that the watchdog signal coming from the first processor is absent.

13. The electronic control apparatus of claim 11, wherein the first and second processors are configured to communicate with each other at intervals, and the second processor is configured to determine whether or not the first processor is malfunctioning, based on a result of the communication.

14. The electronic control apparatus of claim 1, wherein the first monitor includes means for determining whether or not the first processor is malfunctioning, based on a signal outputted from the first processor, and means for resetting the first processor when it is determined that the first processor is malfunctioning.

15. The electronic control apparatus of claim 1, wherein the second monitor includes means for determining whether or not the second processor is malfunctioning, based on a signal outputted from the second processor, and means for resetting the second processor when it is determined that the second processor is malfunctioning.

16. The electronic control apparatus of claim 1, wherein each of the first and second processors is configured to notify a malfunction to outside the apparatus.

17. The electronic control apparatus of claim 1, comprising a memory device which stores data therein independently of being powered or not, wherein the second processor is configured to store, as the data, into the memory device, data showing history of malfunctions which have occurred in the first processor.

18. The electronic control apparatus of claim 4, wherein the first processor is configured to perform a failsafe process and then stop powering the first power supply when it is determined that the second processor is brought into a reset state and unable to be return from the reset state.

19. The electronic control apparatus of claim 3, wherein the second processor is configured to allow the first power supply to be powered from outside the apparatus in response to a command signal inputted from a further electronic control apparatus located outside the apparatus.

20. The electronic control apparatus of claim 3, wherein the second processor is configured to be constantly powered from the second power supply.
